(19) United States
(12) Patent Application Publication
(10) Pub. No.: US 2012/0235595 A1
(43) Pub. Date: Sep. 20, 2012

(54) Method for Setting an Electronic Ballast, an Electronic Ballast and a Compensating Unit

(76) Inventors: Olaf Busse, Munchen (DE); Siegfried Mayer, Moosinning (DE); Marcus Sonst, Munchen (DE)

(21) Appl. No.: 13/512,830

(22) PCT Filed: Nov. 30, 2010
(86) PCT No.: PCT/EP2010/068529

§ 371 Date: May 30, 2012

(30) Foreign Application Priority Data
Nov. 30, 2009 (DE) 10 2009 047 289.4

(51) Int. Cl. G06F 1/04; H05B 37/02

(52) U.S. Cl. 315/291; 713/375

(57) ABSTRACT

A method for setting an electronic ballast (101), wherein the electronic ballast and a compensating unit are synchronized, and wherein setting of the electronic ballast is performed by the compensating unit.

The invention relates to a method for setting an electronic ballast, an electronic ballast, and a compensating unit.

An electronic ballast for a lighting appliance is trimmed and tested at the end of production for example in order to ensure a high degree of reliability and quality.

Trimming is preferably performed on the as yet unpackaged circuit board to enable the individual resistors to be finely adjusted. This approach is laborious because individual components are adjusted in a discrete setting step before the ballast is mounted in an enclosure and only thereafter does assembly take place in a separate operation. If a fault should occur as a result of assembly, this often remains unnoticed, since the testing process has already been completed. If testing is not performed until after assembly, this is equivalent to an additional operation, because trimming and testing are interrupted by an intervening assembly phase.

A ballast can also incorporate a microcontroller, it being likewise necessary or advantageous here for the ballast to be parameterized in a trimming phase. However, if the ballast is assembled together with the microcontroller, access e.g. to the microcontroller's memory is no longer possible.

To adjust the ballast, a compensating unit comprising a controller (e.g. a microcontroller and corresponding peripherals) is used which can preferably exchange data both with a computer (e.g. via an RS232 interface) and with the ballast. The problem here is that the three components PC, compensating unit and ballast are at least partially in an asynchronous state with respect to one another. This effect is in some cases amplified due to the fact that a real-time operating system is not running on the PC, the microprocessors involved are operated at different frequencies, and the frequencies may exhibit particular tolerances.

The object of the invention is to avoid the above-mentioned disadvantages and in particular achieve an efficient means of synchronization between components involved in trimming an electronic ballast.

This object is achieved according to the features of the independent claims. Developments of the invention will emerge from the dependent claims.

To achieve the object, a method for setting an electronic ballast is proposed,
wherein the electronic ballast and a compensating unit are synchronized,
wherein setting of the electronic ballast is carried out using the compensating unit.

By synchronizing the electronic ballast to the compensating unit, an efficient and in particular short ballast setting operation can be achieved.

A development consists in the electronic ballast and the compensating unit being synchronized via a ballast voltage supply.

In particular, an output signal of the voltage supply can be manipulated or modulated such that synchronization information, e.g. a clock signal or a step signal, can be recovered.

In another development, the voltage supply signal is manipulated using a control computer.

For example, the control computer can be in particular a personal computer which is used to initiate synchronization and/or suitably manipulate the ballast voltage supply signal.

In another development, the control computer is linked to the voltage supply via a bus system, in particular via a GPIB, a serial interface, a USB interface or a Bluetooth interface.

Another development consists in the electronic ballast and the compensating unit being synchronized via a synchronization line.

Referring to this, the ballast and the compensating unit can in particular be connected to one another and to the ballast voltage supply via the synchronization line. Preferably both the ballast and the compensating unit each have a synchronization unit for analyzing the synchronization signal.

In another embodiment, the electronic ballast and the compensating unit are synchronized via a modulated voltage supply signal, in particular via voltage dips in the voltage supply signal.

An embodiment also consists in the electronic ballast and the compensating unit being controlled incrementally.

This makes it possible for the ballast and the compensating unit to be controlled in single-step mode, wherein e.g. state transitions can be verified or tested.

An additional embodiment consists in information being transmitted to the electronic ballast in a setting mode of the electronic ballast.

It is therefore advantageous that the electronic ballast can be adjusted, programmed or parameterized in a setting mode. It can also be tested in said setting mode. The setting mode preferably differs from an operating mode of the electronic ballast in which e.g. no setting, i.e. programming, should be performed.

A ballast can be trimmed (if necessary) during the manufacturing process. The ballast is preferably not yet assembled, and so resistors, for example, can be corrected by appropriate component insertion after appropriate measurements. This is time-consuming and requires further testing after assembly to ensure that the ballast is operating properly. The approach presented here allows the ballast to be adjusted in its assembled state, so that testing and trimming can take place in a combined operation.

In a development, the setting mode of the electronic ballast is activated by means of an external signal.

Thus, a specially coded signal can preferably be transmitted via the contacts of the electronic ballast so that the electronic ballast activates setting mode.

In another development, the setting mode of the electronic ballast is activated via appropriate selection of the lamp contacts of the electronic ballast.

In particular, the electronic ballast's contacts provided to connect at least one lamp can be used to transmit the external signal. The advantage of this is that it does not need to have separate contacts for setting the electronic ballast.

In another development, the setting mode of the electronic ballast is activated and/or the information is transmitted to the electronic ballast by simulating a change and/or modulation of a filament coil resistance of a lamp.

Therefore, the existing contacts of the electronic ballast for connecting at least one lighting appliance or lamp can be used to transmit the external signal and activate setting mode. It is also possible for these contacts to be used to transmit information to the electronic ballast. Transmission takes place by modulation of a signal which is detectable by the electronic ballast. The modulation can be used to transmit data.

In another development, the electronic ballast determines measured values and provides them via an interface.

In another development, the electronic ballast provides the measured values via at least one contact for controlling the lamp.

As part of another development, the measured values are transmitted in modulated form.

In particular, frequency, phase or amplitude modulation can be used for this purpose.

A next development consists in the measured values being compared with external measured values and, on the basis of this comparison, information being transmitted to the electronic ballast.

Consequently, it is possible that by comparing the external measured values with the measured values of the ballast, information (e.g. setting parameters) to be transmitted to the electronic ballast can be converted such that any measuring difference between the electronic ballast and a compensating unit is compensated. For example, if the electronic ballast is to be set to a value “14”, whereas a measurement of the electronic ballast delivers a current value “11” and a measurement of the (calibrated) compensating unit delivers a current value “10”, the compensating unit can perform a conversion such that a value “15” is set for the electronic ballast. This means that calibration of the electronic ballast can be dispensed with in that the compensating unit allows for the offset between the determined measured values for setting the electronic ballast.

In one embodiment, the electronic ballast provides measured values or information by modulating a half-bridge frequency of a half-bridge of the electronic ballast.

An alternative embodiment consists in a compensating unit transmitting the external signal and/or the information to the electronic ballast.

In a next embodiment, the electronic ballast is parameterized and/or tested.

It should be noted here that the test can have measured values which can be acquired and output by the device itself. For example, the device may encounter operating points which do not occur in practice. These measured values resulting therefrom can be quickly tested externally for compliance with limit values. In addition, however, relationships between the measured values (e.g. in the form of functions of a plurality of measured values) can also be tested against specified limits.

The above-mentioned object is also achieved by an electronic ballast for at least one lighting appliance or at least one lamp comprising a processor unit or other circuit, e.g. an ASIC, for performing the method described herein.

The above-mentioned object is also achieved by means of a compensating unit for communicating with an electronic ballast, wherein the compensating unit has a controller which is set up such that the method described herein can be performed.

A development consists in the compensating unit being set up for parameterizing, testing and/or setting the electronic ballast.

Exemplary embodiments of the invention will now be presented and explained with reference to the accompanying drawings, in which:

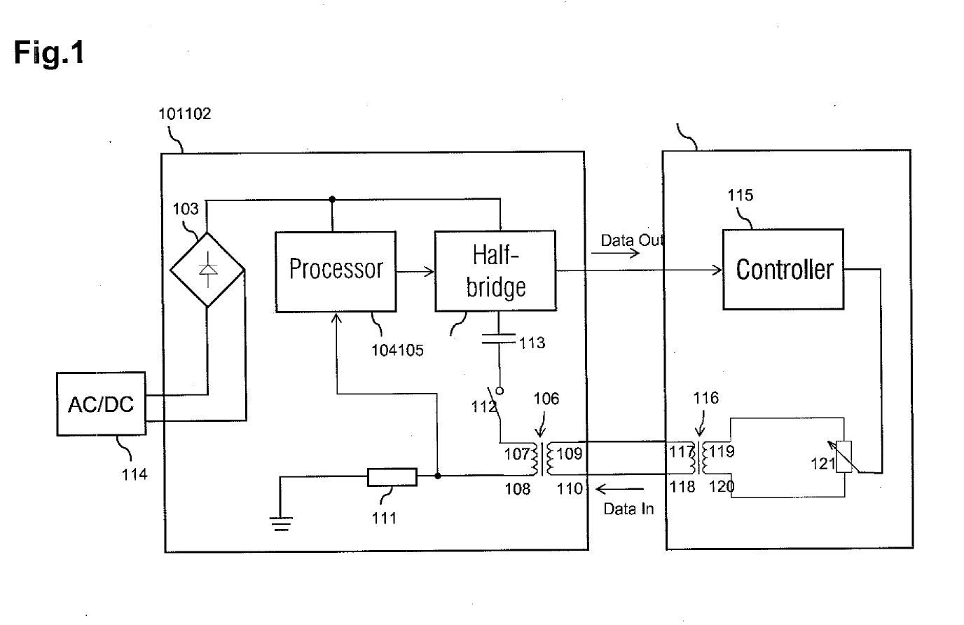

FIG. 1 shows a block schematic comprising an electronic ballast and a compensating unit for setting the electronic ballast;

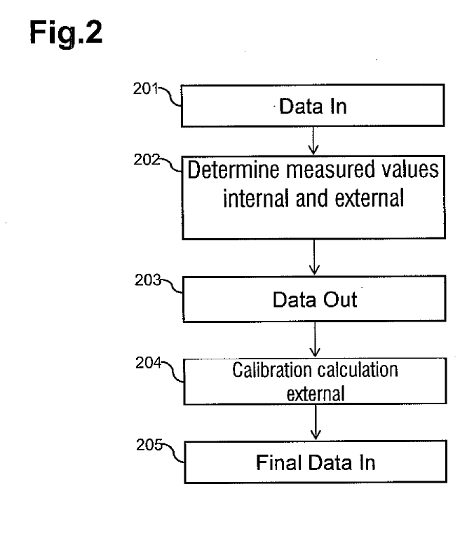

FIG. 2 shows steps of a method for setting or more specifically parameterizing the electronic ballast;

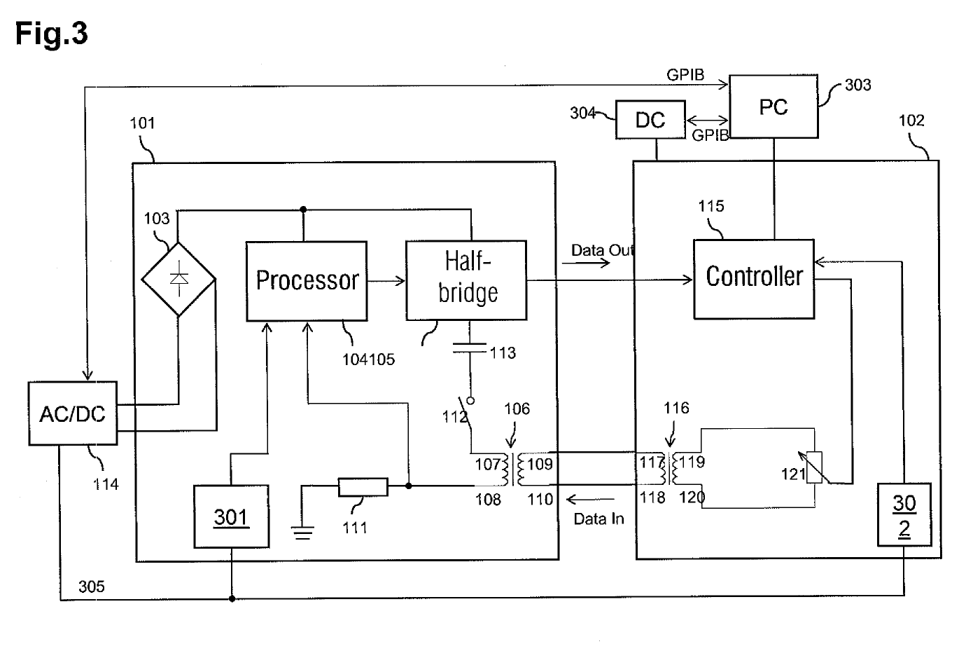

FIG. 3 shows a block schematic for the synchronization of the components involved, based on the block diagram shown in FIG. 1.

With the approach proposed here it is possible to set, parameterize, e.g. trim and/or test, an electronic ballast comprising at least one microcontroller (or correspondingly at least one processor unit with usual external circuitry, i.e. typically with an input/output unit and/or a memory) in an already assembled state.

Parameterization here comprises e.g. transmitting data to the ballast or activating data already accessible to the ballast (e.g. already stored in the ballast's memory). Said parameterization can therefore include transmitting control signals or addressing signals or even (simple) codes on the basis of which the ballast can carry out a corresponding parameterization.

For example, it is possible for a compensating unit to transparently transmit data to the ballast which the ballast is to use. Examples of such data include:
a lamp type,
a lamp current, possibly a lamp current range,
parameters for safety disconnection, e.g. limit voltage values, the reaching or exceeding of which is to cause the ballast to be shut down,
a power limit,
identification information, e.g. including a serial number,
production data,
manufacturer-specific data.

The data may also already be stored in a memory of the ballast and activated by transmission of access information from the compensating unit to the ballast.

Communication with the ballast can take place in different ways.

For example, it is possible for the ballast to be controlled via a compensating unit. In this case the compensating unit simulates a lighting appliance, wherein the compensating unit can, for example, vary a filament coil resistance of the lighting appliance. This enables information to be transmitted from the compensating unit to the ballast.

It is also possible for information to be received from the ballast. This can be achieved by varying a half-bridge frequency of the ballast. Thus e.g. frequency-modulated data can be transmitted from a half-bridge of the ballast to the compensating unit.

In particular, the compensating unit can first send a trigger signal to the ballast which causes the ballast to change to setting mode. In setting mode, the ballast responds to transmission of information from the compensating unit. When setting of the ballast has been completed, another signal can be sent to the ballast which terminates setting mode. It is also possible for the ballast to register a time lapse, i.e. an overshoot of a period of time since the last information from the compensating unit, and as a result itself terminate setting mode.

FIG. 1 shows a block schematic comprising a ballast 101 and a compensating unit 102.

The ballast 101 comprises a rectifier 103, a processor 104, a half-bridge 105, a transformer 106 (having a primary side comprising terminals 107, 108 and a secondary side comprising terminals 109, 110), a resistor 111 as well as a switch 112 and a capacitor 113.

The rectifier 103 is connected at the input side to a voltage source 114 and supplies the processor 104 and the half-bridge 105 with a DC voltage.

The terminal 107 of the transformer 106 is connected to the half-bridge 105 via the series-connected switch 112 and capacitor 113. The terminal 108 of the transformer 106 is connected on one side to ground via the resistor 111 and on the other side to the processor 104. The processor 104 controls the half-bridge 105, in particular electronic switches (not shown) of the half-bridge 105.

The compensating unit 102 comprises a controller 115, a transformer 116 (having a primary side comprising terminals 117, 118 and a secondary side comprising terminals 119, 120) and a variable resistor 121.

The terminals 119, 120 of the transformer 116 are interconnected via the variable resistor 121, wherein the resistor 121 can be influenced via the controller 115. The terminal 117 of the transformer 116 is connected to the terminal 109 of the transformer 106 and the terminal 118 of the transformer 116 is connected to the terminal 110 of the transformer 106.

In addition, the half-bridge 105 is connected to the controller 115.

In normal operating mode, the switch 112 brings the transformer 106 into circuit in order to heat the filament coil of the lamp. During continuous operation, this heating function can be deactivated again. To receive data, the switch 112 is closed. Such a closure can be initiated by a signal from the voltage source 114, which signal is analyzed by the processor 104. The switch 112 can also already be closed because a filament coil has previously been detected: thus the ballast can identify whether a filament coil is present, e.g. by means of a small test current.

It is therefore advantageous that trimming and testing of the ballast can be carried out in one step after the ballast has been assembled, thereby saving a production step and therefore reducing the time required to manufacture the ballast. Space on the ballast circuit board is also saved, since no separate test adapter or test connector is required. Altogether the costs for calibrating and testing the ballast can be reduced.

Another advantage consists in the fact that the ballast can be flexibly and customer-specifically programmed by importing and/or activating the operating parameters e.g. for specific lamps and/or customer requirements, in particular at the end of production.

For trimming, internal and external measurements can be performed in a synchronized manner. The internal measurement results can be aligned with the external measurement results, any tolerances being efficiently compensated by the comparison measurements. It is therefore possible that components can be more generously (e.g. more imprecisely) dimensioned, thereby reducing manufacturing costs.

FIG. 2 shows steps of a method for setting i.e. parameterizing, the electronic ballast.

In a step 201, initial data is sent from the compensating unit to the ballast, thus initiating parameterization. In a step 202, the ballast determines measured values (also referred to as internal measured values), while the compensating unit likewise determines measured values (also referred to as external measured values). In a step 203, the ballast provides the internal measured values to the compensating unit. On the basis of the measured values provided, the compensating unit can perform, in a step 204, a calibration calculation taking into account the external (i.e. its own) measured values and, in a step 205, transmit the result of the calibration calculation to the ballast.

By means of the two measurements and the subsequent comparison, the compensating unit can effectively eliminate a measurement error of the ballast by e.g. equalizing an offset of the ballast by means of the comparison measurement of the compensating unit. This makes it possible, on the basis of said comparison measurement, to perform parameterization of values in the ballast with a high degree of accuracy.

The type of trimming proposed here also enables parameters to be aligned which result from a plurality of parameters which can be determined by the electronic ballast and/or by the compensating unit. In particular, it is possible for the electronic ballast to provide a target which is set on the basis of a plurality of parameters, measured by the ballast.

This approach allows efficient synchronization of components required for trimming a ballast. In particular, the ballast can also be synchronized with these components.

A control computer, e.g. a PC (personal computer) can have a software package which manipulates a supply voltage such that the manipulation is detectable by the ballast and/or the compensating unit and can accordingly be used for synchronization of a time base.

For example, by means of the software, on the basis of a DC voltage, voltage dips can be generated for a predefined time using a power supply, said power supply supplying the ballast with electrical power. The voltage dips can be detected in each case using a synchronization unit and analyzed by a ballast processor or a compensating unit controller. In particular, an existing A/D converter of the ballast processor or of the compensating unit controller can be used for this purpose.

FIG. 3 shows a block schematic for the synchronization of the components involved, based on the block diagram shown in FIG. 1. In respect of the parts of FIG. 3 already described in connection with FIG. 1, reference is made to the above description.

As the control computer, FIG. 3 shows a PC 303 on which control software is run. Using the control software, the voltage supply 114 is manipulated via a bus system, e.g. a GPIB (General Purpose Interface Bus, e.g. IEC 625 bus), such that e.g. voltage dips are produced which do not adversely affect the operation of the ballast 101, but can be used for synchronization. Alternatively, instead of (or in addition to) the GPIB, a serial interface, a USB interface or a Bluetooth interface can also be present.

Instead of the voltage dips, the output signal of the voltage supply 114 can be modified in different ways such that, on the one hand, the supply of power to the ballast 101 is ensured and, on the other, the modification can be used for synchronization. For example, the output signal of the voltage supply 114 can be modulated within predefined ranges for this purpose, the synchronization information being contained in the modulation.

For this purpose, the output signal of the voltage supply 114 is supplied to a synchronization unit 301 of the ballast 101, said synchronization unit 301 forwarding e.g. the detected voltage dips to the processor 104 for analysis. Accordingly, the processor 104 can perform synchronization with the time instants of the voltage dips.

Correspondingly, the output signal of the voltage supply 114 is supplied to a synchronization unit 302 of the compensating unit 102, said synchronization unit 302 forwarding e.g. the detected voltage dips to the controller 115 for analysis. Accordingly, the controller 115 can perform synchronization with the time instants of the voltage dips.

It is therefore advantageous that a synchronization line 305 interconnects the synchronization units 301, 302 and the voltage supply 114.

In addition, FIG. 3 shows DC voltage supply 304 which is controlled by the PC 303 via a bus system (e.g. GPIB) and supplies the compensating unit 102 with electrical power.

It is therefore advantageous that process reliability can be significantly improved by means of the described synchronization. The entire operation of setting or trimming the ballast can be shortened, and prioritization of PC processes can be dispensed with. The operation of setting or trimming the ballast can therefore be largely decoupled from the performance of the PC.

Another advantage consists in the possibility of manual control, i.e. a change from one state to the next can take place on a time-independent basis and be monitored accordingly (single-step mode).

### LIST OF REFERENCE CHARACTERS

101 Ballast
102 Compensating unit
103 Rectifier
104 Processor
105 Half-bridge
106 Transformer
107-110 Terminals of transformer 106
111 Resistor
112 Switch
113 Capacitor
114 Voltage supply
115 Controller
116 Transformer
117-120 Terminals of transformer 116
121 Variable resistor
301 Synchronization unit
302 Synchronization unit
303 PC (Personal Computer)
304 DC voltage supply
305 Synchronization line

1. A method for setting an electronic ballast, wherein the electronic ballast and a compensating unit are synchronized, and wherein setting of the electronic ballast is performed by the compensating unit.

2. The method as claimed in claim 1, wherein the electronic ballast and the compensating unit are synchronized via a ballast voltage supply.

3. The method as claimed in claim 2, wherein the voltage supply signal is manipulated by means of a control computer.

4. The method as claimed in claim 3, wherein the control computer is coupled to the voltage supply via a bus system, a serial interface, a USB interface or via a Bluetooth interface.

5. The method as claimed in claim 1, wherein the electronic ballast and the compensating unit are synchronized via a synchronization line.

6. The method as claimed in claim 1, wherein the electronic ballast and the compensating unit are synchronized via a modulated voltage supply signal.

7. The method as claimed in claim 1, wherein the electronic ballast and the compensating unit are controlled incrementally.

8. The method as claimed in claim 1, wherein, in a setting mode of the electronic ballast, information is transmitted to the electronic ballast.

9. The method as claimed in claim 8, wherein the setting mode of the electronic ballast is activated by an external signal.

10. The method as claimed in claim 8, wherein the setting mode of the electronic ballast is activated via appropriate controlling of the lamp contacts of the electronic ballast.

11. The method as claimed in claim 8, wherein the setting mode of the electronic ballast is activated and/or wherein the information is transmitted to the electronic ballast by simulating a change in and/or modulation of a filament coil resistance of a lamp.

12. The method as claimed in claim 8, wherein the compensating unit transmits the external signal and/or the information to the electronic ballast.

13. The method as claimed in claim 8, wherein the electronic ballast determines measured values and provides them to the compensating unit via an interface.

14. The method as claimed in claim 13, wherein the electronic ballast provides the measured values via at least one contact for controlling the lamp.

15. The method as claimed in claim 13, wherein the measured values are transmitted in modulated form.

16. The method as claimed in claim 13, wherein the measured values are compared with external measured values and, on the basis of the comparison, information is transmitted to the electronic ballast.

17. The method as claimed in claim 1, wherein the electronic ballast provides measured values or information by modulating a half-bridge frequency of a half-bridge of the electronic ballast.

18. The method as claimed in claim 1, wherein the electronic ballast is parameterized and/or tested using the compensating unit.

19. An electronic ballast for at least one lighting appliance or at least one lamp, comprising a processor unit or other circuit for performing the method as claimed in claim 1.

20. A compensating unit for communicating with an electronic ballast, wherein the compensating unit has a controller which is set up such that the method as claimed in claim 1 can be performed.

21. A compensating unit as claimed in claim 20 for parameterizing, testing and/or setting the electronic ballast.
